(19) United States
(12) Patent Application Publication
(10) Pub. No.: US 2007/0205894 A1
(43) Pub. Date: Sep. 6, 2007

(54) Radio frequency identification for asset management

(75) Inventors: Dean H. Nelson, Union City, CA (US); Robert Bivona, San Pablo, CA (US)

Correspondence Address: SUN MICROSYSTEMS, INC. c/o DORSEY & WHITNEY, LLP, 370 SEVENTEENTH ST., SUITE 4700, DENVER, CO, 80202, US

(73) Assignee: Sun Microsystems, Inc.

(21) Appl. No.: 11/364,956

(22) Filed: Mar. 1, 2006

(51) Int. Cl. G08B 13/14; G06Q 30/00; G06F 7/00; G08B 5/22

(52) U.S. Cl. 340/572.1; 235/385; 700/225; 340/825.49

(57) ABSTRACT

In one embodiment, a method and apparatus for radio frequency identification for asset management are disclosed. The method includes providing a radio frequency identification (RFID) tag to an asset to be tracked via an asset management system, activating the RFID tag, transmitting from the RFID tag identification information of the asset to the asset management system, and tracking the asset from the RFID tag identification information with the asset management system. Other embodiments are also disclosed.

### FIELD OF INVENTION

An embodiment of the invention relates to asset management, and more specifically, to radio frequency identification for asset management.

### BACKGROUND OF INVENTION

Many organizations track their information technology (IT) assets. The asset tracking can be a dynamic process, with many different assets moving in and out, going on or offline on a daily, or even hourly, basis. The organizations may have tens of thousands of systems and other assets at any given time, and knowing what is in place and available is important to the organization for financial and efficiency reasons. These organizations may utilize asset tracking systems to track the assets, but these systems do incomplete jobs.

Currently, tracking of assets has been traditionally accomplished through asset management products that discover and maintain a repository of asset and license data to enable organizations to track inventory, manage license usage, and enforce IT governance audit controls. These products typically tie into a configuration management database (CMDB) to help report accurate and timely information about all assets, aggregated from multiple systems.

Typically, the discovery of assets is accomplished through the use of bar codes on the assets. For example, in a high-density server rack, bar codes can be placed on the back of each component in the server rack. Yet, cables and power cords can make the line-of-sight access to scan the bar code difficult. A traditional bar code method of tracking assets may also take from five to twenty minutes to read each server rack. Using trained personnel, it could take weeks to perform a wall-to-wall inventory of assets. Invariably, user errors contribute to an incomplete picture of asset inventory, and the information is nearly out of date once the task is completed. Such a system can cost estimated millions of dollars on an annual basis to some organizations.

Furthermore, under existing inventory management systems, not all assets contain bar codes, and it is difficult to count them. Yet, these items are essential when deploying test and development environments. In addition, some existing systems rely on network-based asset tracking systems. These network-based systems can do incomplete jobs because items not powered up or disconnected from the network are invisible to the tracking system. Furthermore, some items that are important to track may not be capable of being tracked over a network. For example, IT-related non-networked items that would not be tracked by such a system may include server racks, power distributions units, uninterruptible power supplies, and not-in-use spares for network components.

Therefore, an asset tracking system that accurately tracks networked, as well as non-networked, assets in a timely and efficient manner would be beneficial.

### SUMMARY OF INVENTION

The present invention includes novel methods and apparatus for radio frequency identification for asset management.

According to one embodiment of the invention, a method is disclosed. The method includes providing a radio frequency identification (RFID) tag to an asset to be tracked via an asset management system, activating the RFID tag, transmitting from the RFID tag identification information of the asset to the asset management system, and tracking the asset from the RFID tag identification information with the asset management system.

According to another embodiment of the invention, an apparatus is disclosed. The apparatus includes an asset of an organization to be tracked via an asset management system, and an RFID tag connected to the asset to identify the asset to the asset management system by transmitting a signal to the asset management system when the RFID tag is activated.

### BRIEF DESCRIPTION OF THE DRAWINGS

The invention may be best understood by referring to the following description and accompanying drawings that are used to illustrate embodiments of the invention. In the drawings:

FIG. 1 is a block diagram of various assets to be tracked with a radio frequency identification (RFID) tracking system according to one embodiment of the invention;

FIG. 2 is a block diagram illustrating one embodiment of a close-up view of a variety of information technology (IT) assets tracked via an asset management system utilizing RFID tags;

FIG. 3 is a flow diagram illustrating a method according to one embodiment of the invention;

FIG. 4 is a block diagram illustrating a variety of assets tracked via an asset management system without intervention from a user according to one embodiment of the invention; and

FIG. 5 is an illustration of an embodiment of a computer system.

### DETAILED DESCRIPTION

A method and apparatus are described for radio frequency identification (RFID) for asset management. According to one embodiment, the method includes providing a radio frequency identification (RFID) tag to an asset to be tracked via an asset management system, activating the RFID tag, transmitting from the RFID tag identification information of the asset to the asset management system, and tracking the asset from the RFID tag identification information with the asset management system.

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions, to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, hard disk, optical disks, CD-ROMs, and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data. Moreover, data discussed herein may be stored in a single database, multiple databases, or otherwise in select forms (such as in a table).

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly herein, a carrier wave shall be regarded as comprising a machine-readable medium.

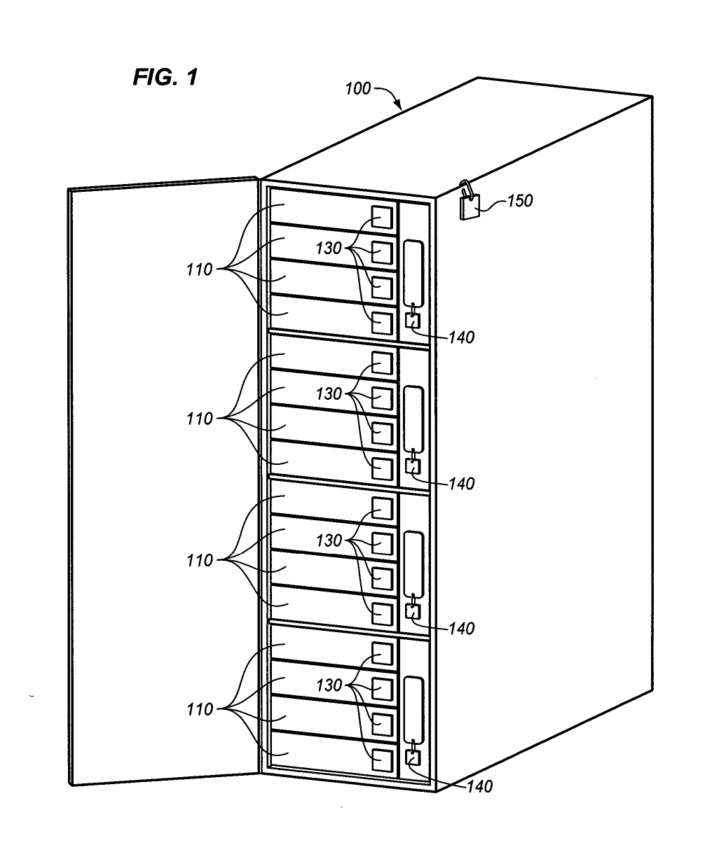

Embodiments of the invention introduce a novel method for RFID tag design for asset management. FIG. 1 is a block diagram illustrating various assets to be tracked with a RFID tag via an asset management system according to one embodiment of the invention. A server rack 100 is illustrated including a variety of assets 110. In various embodiments of the invention, the components illustrated in FIG. 1 may be representative of those an organization may track with an asset management system. One skilled in the art will appreciate that embodiments of the invention may apply to more than a server rack, and that the server rack is used for illustrative purposes of the entire concept of embodiments of the invention.

Assets 110 may be a variety of IT components including, but not limited to, servers, storage devices, network switches, terminal servers, power distribution units, server racks, and so on. In one embodiment, server rack 100 may include many different types of assets 110, such as servers or other IT assets that may be operated from a server rack.

RFID tags 130, 140, 150 are attached to every asset that is to be tracked via an asset management system. In one embodiment, the asset management system may be maintained by an organization controlling the assets 110. The RFID tags 130, 140, 150 may be synchronized with appropriate information in a database, including a description, owner, device serial number, location ID, and so on. In one embodiment, a previous bar code on an asset may be utilized for the synchronization. The information associated with the barcode is synchronized in the database to be further associated with the asset's new RFID tag 130, 140, 150.

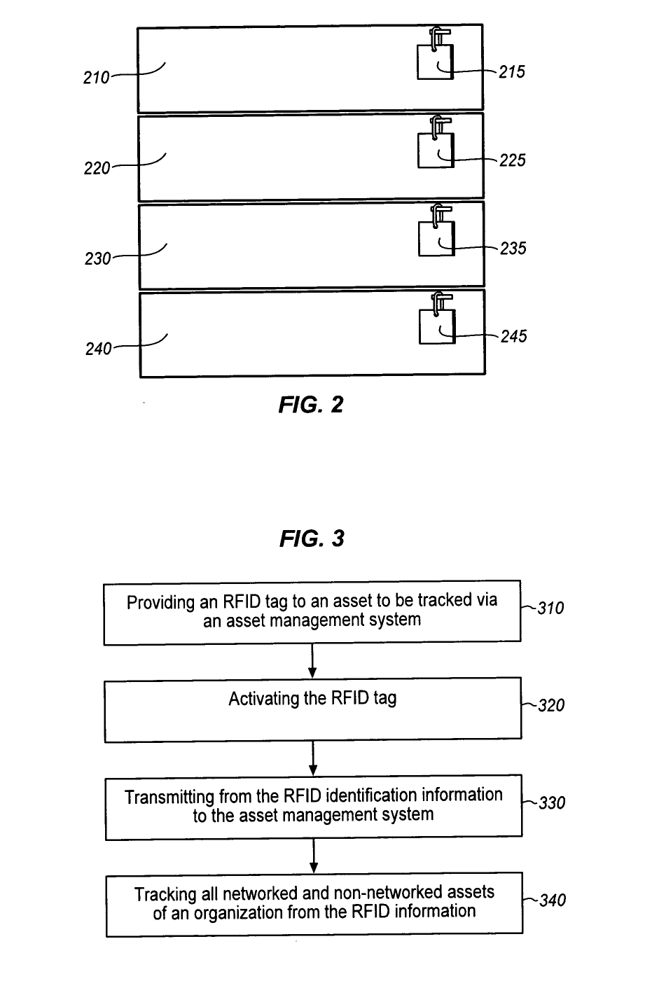

FIG. 2 is a block diagram illustrating a close-up view of a variety of IT assets tracked via an asset management system utilizing RFID tags. IT assets 210, 220, 230, 240 may be any one of variety of assets that an organization may track with an asset management system. In one embodiment, assets 210-240 are the same as assets 110 described with respect to FIG. 1. Assets 210-240 further include RFID tags 215, 225, 235, 245 attached to each of assets 210-240. These RFID tags 215-245 may utilize RFID technology that is well known in the art.

In one embodiment, the RFID tags 215-245 are passive tags. This means that the tag does not include its own battery or other power source. Passive tags typically are made of less expensive material and components, and therefore require less cost to implement. An outside source, such as an antenna, activates the passive tag so that the tag sends a signal. This signal includes the identification information of the asset to be tracked by the asset management system. An outside source may then read the signal being sent by the asset for the asset management system. In one embodiment, this outside source may be the same source that activated the tag.

In other embodiments, it is envisioned that the RFID tags 215-245 may be any one of or a combination of passive, semi-passive, or active tags. Semi-passive tags include a battery that powers the tag, but otherwise do not have the requisite power to send a transmission signal to an antenna. Active tags include a power source that supports that tag powering up, as well as supports transmitting signals to an antenna.

In some embodiments, the actual size of the RFID tag 215-245 is no bigger than the actual height of the component the tag is identifying. For example, the RFID tag may be one inch by one inch in size. In other embodiments, the tag is internally made of a foam material with a type of Mylar on the outside of the tag. This helps protect the tag from various outside forces that can affect the correct operation of the tag, such as pulling, twisting, and banging on the tag.

In other embodiments, the RFID tag 215-245 is orientated at a horizontal angle to the antenna that is powering the tag in order to facilitate correct operation of the tag. In addition, the RFID tag 215-245 may also be offset at least a quarter-inch away from the asset it is identifying in order to reduce interference between the asset and the RF signal from the tag. In one embodiment, a boot or other structure may be used to facilitate the tag's offset from the asset.

In still other embodiments, it is envisioned that a variety of attachments may be utilized to attach the RFID tag 215-245 to an asset. For example, at least one of or a combination of a clip, tie, or adhesive material may be utilized to attach the tag to the asset. This attachment may be used in such a way as to maintain the other requirements, such as orientation and offset, for the correct operation of the RFID tag.

FIG. 3 is a flow diagram illustrating a method of one embodiment of the invention. Process 300 operates to provide asset tracking via RFID tags for an asset management system. The process 300 begins at processing block 310 where an RFID tag is provided to an asset that is to be tracked via the asset management system. Then, at processing block 320, the RFID tag is activated. There are a variety ways to activate that tag, which will be described further below.

At processing block 330, RFID tag information is transmitted from the RFID tag to the asset management system. Then, at processing block 340, all network and non-networked assets of the organization may be tracked from the collection of the RFID information from the assets via the RFID tags.

As discussed above, there are a variety of ways to activate an RFID tag. In some embodiments of the invention, a handheld reader may be passed in front of the RFID tags to active the tags and instantly record the identification information of the tags. For example, an entire server rack, which could contain up to fifty devices, may be recorded in a few seconds. The asset management system records all assets with tags, including those connected to a network and those that are not connected to a network. In order to track assets with the handheld reader, a user may be needed to operate the handheld reader. Other embodiments may utilize technology which does not require user interaction to track the assets.

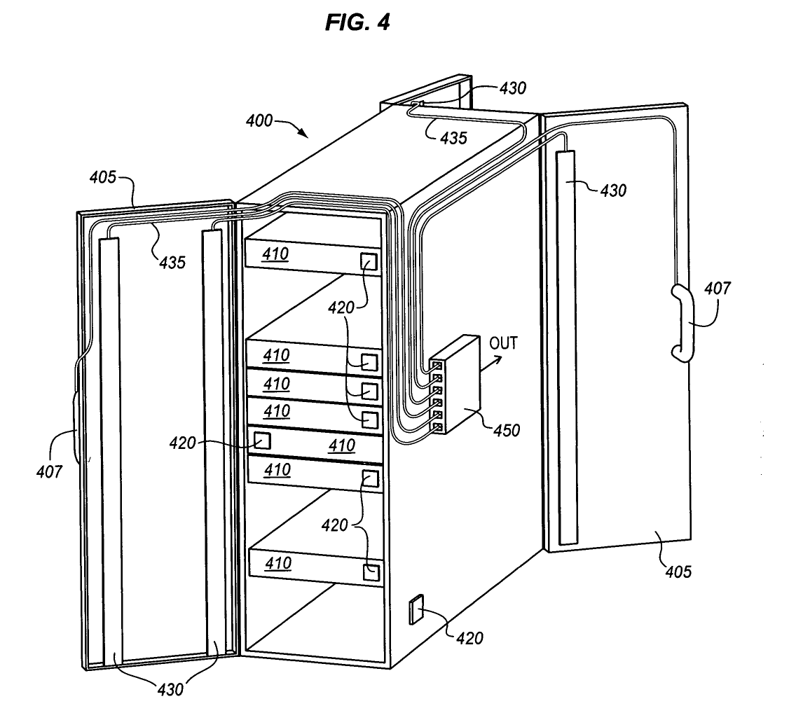

For example, FIG. 4 is a block diagram of a variety of assets that may be tracked with an asset management system without intervention from a user to gather the asset information from the RFID tags. A server rack 400 including a variety of IT assets 410 may be tracked via an asset management system. In various embodiments of the invention, the components illustrated in FIG. 4 may be representative of those an organization may track with an asset management system. One skilled in the art will appreciate that embodiments of the invention may apply to more than a server rack, and that the server rack is used for illustrative purposes of the entire concept of embodiments of the invention.

The server rack 400 and components further include RFID tags 420 with identifying information that may be correlated to information related the devices in a database. In one embodiment, the server rack 400 includes one or more strip antennas 430 running the vertical length of doors 405 of the server rack 400. The strip antennas 405 may be utilized to active and read RFID tags 420, which in some embodiments may be passive tags.

In one embodiment, instead of a handheld reader being used to activate the RFID tags 420 to gather the device information of the assets 410, the strip antennas 430 may be controlled from a central control unit (not shown) to transmit a signal that activates the RFID tags 420. In this manner, the RFID tags 420 may then transmit the identifying information for the assets 410 being tracked through the strip antennas 430.

In some embodiments, strip antennas 430 are positioned on opposite ends of the server rack doors 405 in order to activate tags that are located on either side of an asset that is being tracked. In some embodiments, the strip antennas 430 may be located on both front and back doors of the server rack 400 to enable activation and reads from both sides of the server rack 400. One skilled in the art will appreciate that strip antennas 430 may be located at various locations on the server rack 400 other than how illustrated. For instance, strip antennas 430 may be located inside the structure of the server rack 400 instead of on the doors 405.

In one embodiment, the strip antennas 430 may be connected via wiring 435 to a collection device 450 that collects all of the RFID information to transmit to the asset management system. In some embodiments, the collection device 450 may transmit over an Ethernet connection to a central inventory management system of the asset management system.

In other embodiments, the wiring 435 from strip antennas 430 may be connected to a remote collection device (not shown) that is separately located from the server rack 400. In one embodiment, the wiring 435 may utilize standard RJ45 ports to connect to the remote collection device. In yet another embodiment, the wiring 435 may be connected to another server rack 400 or another IT asset.

In one embodiment, the doors 405 of the server rack 400 may further include handles 407 that are electrically connected with a sensor so that when the doors 405 are opened the strip antennas 430 are disabled. The sensors on handles 407 may further be connected via wiring 435 to the collection device 450. In this manner, collection device may control strip antennas 430 for the situations when the doors 405 are either opened or closed.

In some embodiments, the collection devices, either central or remote, provide the collected asset information to the asset management system for consolidation. The asset management system may be the central repository for all of the asset information. It may then, in turn, dynamically validate the asset information at a set frequency (e.g., daily, weekly, monthly) and initiate events to reconcile discrepancies that may be found.

One skilled in the art will appreciate the embodiments of the invention may be applied to assets other than server racks or computer components. Embodiments of the invention allow for assets that are not connected to a network to be tracked via RFID tags.

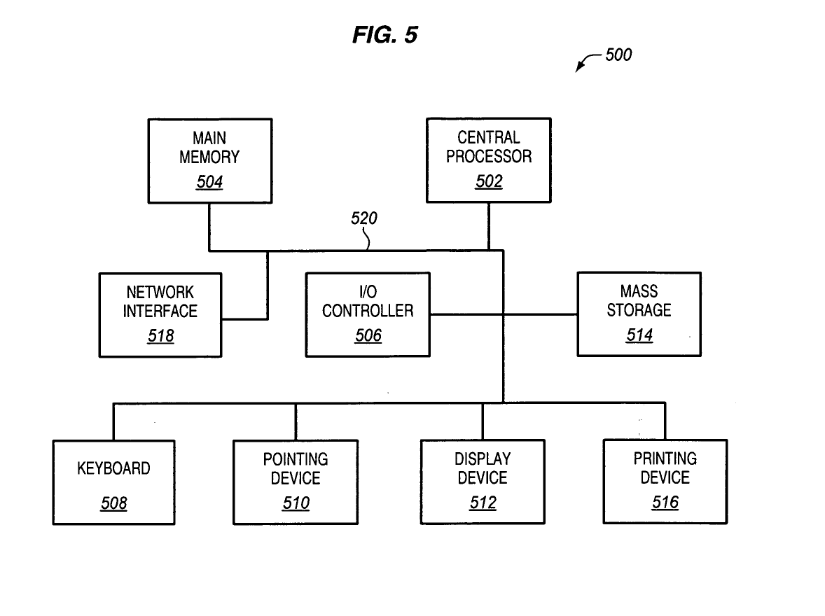

FIG. 5 illustrates an exemplary computer system 500 in which certain embodiments of the present invention may be implemented. In one embodiment, the components of FIG. 1 may be implemented as system 500 or as components of system 500.

System 500 comprises a central processor 502, a main memory 504, an input/output (I/O) controller 506, a keyboard 508, a pointing device 510 (e.g., mouse, track ball, pen device, or the like), a display device 512, a mass storage 514 (e.g., a nonvolatile storage such as a hard disk, an optical drive, and the like), and a network interface 518. Additional input/output devices, such as a printing device 516, may be included in the system 500 as desired. As illustrated, the various components of the system 500 communicate through a system bus 520 or similar architecture.

In a further embodiment, system 500 may be a distributed computing system. In other words, one or more of the various components of the system 500 may be located in a physically separate location than the other components of the system 500. Such components may be accessed and connected via a network to the other components

In accordance with an embodiment of the present invention, the computer system 500 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.).

Also, instead of a single processor, two or more processors (whether on a single chip or on separate chips) can be utilized to provide speedup in operations. It is further envisioned that the processor 502 may be a complex instruction set computer (CISC) microprocessor, a reduced instruction set computing (RISC) microprocessor, a very long instruction word (VLIW) microprocessor, a processor implementing a combination of instruction sets, and the like.

The network interface 518 provides communication capability with other computer systems on a same local network, on a different network connected via modems and the like to the present network, or to other computers across the Internet. In various embodiments of the present invention, the network interface 518 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 500 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 500 is a general purpose computer capable of running any number of applications such as those available from companies including Oracle, Siebel, Unisys, Microsoft, and the like.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

The foregoing description has been directed to specific embodiments. It will be apparent to those with ordinary skill in the art that modifications may be made to the described embodiments, with the attainment of all or some of the advantages. Therefore, it is the object of the appended claims to cover all such variations and modifications as come within the spirit and scope of the invention.

What is claimed is:

1. A method comprising:
providing a radio frequency identification (RFID) tag to an asset to be tracked via an asset management system;
activating the RFID tag;
transmitting from the RFID tag identification information of the asset to the asset management system; and
tracking the asset from the RFID tag identification information with the asset management system.

2. The method of claim 1, wherein the asset is an information technology (IT) asset of an organization.

3. The method of claim 2, wherein the asset is not communicatively connected to any networks of the organization.

4. The method of claim 1, wherein the RFID tag is offset from the asset to reduce interference from the asset with the RFID tag.

5. The method of claim 1, wherein the RFID tag is a passive tag and activating the passive RFID tag further comprises sending a signal to the RFID tag from a handheld RFID tag reader to power the RFID tag to send the identification information.

6. The method of claim 1, wherein activating the RFID tag further comprises sending a signal from a strip antenna to the RFID tag to power the RFID tag to send the identification information, the strip antenna situated on an apparatus containing the asset.

7. The method of claim 6, wherein the strip antenna is controlled from a remote central unit that manages the collection of the identification information of the asset.

8. An article of manufacture, comprising a machine-accessible medium including data that, when accessed by a machine, cause the machine to perform operations comprising:
providing a radio frequency identification (RFID) tag to an asset to be tracked via an asset management system;
activating the RFID tag;
transmitting from the RFID tag identification information of the asset to the asset management system; and
tracking the asset from the RFID tag identification information with the asset management system.

9. The article of manufacture of claim 8, wherein the asset is an information technology (IT) asset of an organization.

10. The article of manufacture of claim 9, wherein the asset is not communicatively connected to any networks of the organization.

11. The article of manufacture of claim 8, wherein the RFID tag is offset from the asset to reduce interference from the asset with the RFID tag.

12. The article of manufacture of claim 8, wherein activating the RFID tag further comprises sending a signal to the RFID tag from a handheld RFID tag reader to power the RFID tag to send the identification information.

13. The article of manufacture of claim 8, wherein activating the RFID tag further comprises sending a signal from a strip antenna to the RFID tag to power the RFID tag to send the identification information, the strip antenna situated on an apparatus containing the asset.

14. The article of manufacture of claim 13, wherein the strip antenna is controlled from a remote central unit that manages the collection of the identification information of the asset.

15. An apparatus, comprising:
an asset of an organization to be tracked via an asset management system; and
an RFID tag connected to the asset to identify the asset to the asset management system by transmitting a signal to the asset management system when the RFID tag is activated.

16. The apparatus of claim 15, wherein the asset is not communicatively coupled to any networks of an organization controlling the asset.

17. The apparatus of claim 15, wherein the RFID tag is activated by sending a signal to the RFID tag from a handheld RFID tag reader to power the RFID tag to send the identification information.

18. The apparatus of claim 15, further comprising a strip antenna on a unit that contains the asset, the strip antenna to activate the RFID tag by sending a signal from the strip antenna to the RFID tag to power the RFID tag to send the identification information.

19. The apparatus of claim 18, further comprising a remote central unit to control the strip antenna in order to manage the collection of the identification information from the RFID tag of the asset.

20. The apparatus of claim 18, further comprising a collection element connected to the unit that contains the asset, the collection unit to gather the identification information of the asset in order to transmit the identification unit to the asset management system.
